(19) United States
(12) Patent Application Publication
(10) Pub. No.: US 2020/0317245 A1
(43) Pub. Date: Oct. 8, 2020

(54) CAMERA DOLLY ELECTRICAL SYSTEM

(71) Applicant: CHAPMAN/LEONARD STUDIO EQUIPMENT, INC., North Hollywood, CA (US)

(72) Inventor: Leonard T. Chapman, North Hollywood, CA (US)

(21) Appl. No.: 16/542,114

(22) Filed: Aug. 15, 2019

Related U.S. Application Data
(60) Provisional application No. 62/830,925, filed on Apr. 8, 2019.

(51) Int. Cl. B62B 5/00; B66F 11/04; G03B 17/56; H04N 5/225

(52) U.S. Cl. CPC B62B 5/0053; H04N 5/2251; G03B 17/561; B66F 11/048

(57) ABSTRACT

A camera dolly includes an electrical system for powering a hydraulic system for raising and lowering the camera dolly arm or pedestal. The electrical system has an on-board or in-board battery, such as a lithium battery, contained within the dolly chassis. The dimensions and mechanical configuration of the dolly may optionally remain unchanged by the addition of the electrical system and lithium battery. As a result, existing camera dollies may be retrofitted with the present electrical system. The present electrical system provides a camera dolly with on-board electrical power for charging the hydraulic system. The camera dolly consequently can operate for long periods of time without access to wall current, and without using a manual pump for the hydraulic system.

### CROSS-REFERENCE TO RELATED APPLICATION

This application claims priority to and the benefit of U.S. Provisional Application No. 62/830,925, filed Apr. 8, 2019, incorporated herein by reference.

### BACKGROUND OF THE INVENTION

The field of the invention is camera dollies. More specifically, the application relates to an electrical system in a camera dolly. Many camera dollies have an arm or column which is raised and lowered via an actuator, which is often a hydraulic actuator. In this type of dolly or pedestal, the hydraulic actuator is powered by a hydraulic system including a pump and an accumulator. The pump is driven by an electric motor. Operating the pump charges the accumulator to maintain sufficient hydraulic pressure to operate the actuator. To allow for near silent operation, during filming the electric motor and the pump are switched off. The accumulator is charged by switching the electric motor and the pump on typically only during time intervals between actual filming.

The electric motor is typically powered by wall current. However, this of course requires that the dolly be connected to a power cable, which can be inconvenient, and which can interfere with maneuvering the dolly, as may be needed to follow actors or a filmed action sequence. In addition, often wall current is not available, for example when filming outdoors. Alternatively, the accumulator can be charged using a manual pump of the hydraulic system, although this is slower than pumping via the electric motor. The manual pump also requires substantial human effort. Although these types of camera dollies have performed well in the past, an improved dolly providing more versatile operation is needed.

### SUMMARY OF THE INVENTION

A camera dolly includes an electrical system for powering a hydraulic system for raising and lowering the camera dolly arm or pedestal. The electrical system has an on-board or in-board battery, such as a lithium battery, contained within the dolly chassis. The dimensions and mechanical configuration of the dolly may optionally remain unchanged by the addition of the electrical system and lithium battery. As a result, existing camera dollies may be retrofitted with the present electrical system. The present electrical system provides a camera dolly with on-board electrical power for charging the hydraulic system. The camera dolly consequently can operate for extended periods of time without access to wall current or other electrical power source such as an auxiliary battery, and without using a manual pump for the hydraulic system. Indeed, the manual pump may be omitted entirely.

In one aspect, a chassis having a left frame, a right frame, and a rear frame. An arm is pivotally attached to the chassis. A hydraulic system includes a pump, an accumulator and a hydraulic actuator connected to the arm, for raising and lowering the arm. The pump and the accumulator are in the left frame. The hydraulic system also have one or more auxiliary air tanks in the left frame. An electrical system includes a battery removably installed into the right frame, an AC to DC converter electrically connected to the battery and to connector on the chassis. A motor connected to the electrical system drives the pump.

Other objects, features and advantages will become apparent from the following detailed description, which is provided by way of explanation and is not intended to indicate the limits of the invention.

### BRIEF DESCRIPTION OF THE DRAWINGS

In the drawings, the same reference number indicates the same element in each of the views.

FIG. 1 is a front and right side perspective view of a camera dolly.

FIG. 2 is a front, top and left side exploded perspective view of a new camera dolly with various components omitted for purpose of illustration.

FIG. 3 is a rear, top and left side exploded perspective view of the camera dolly shown in FIG. 2 with various components omitted for purpose of illustration.

FIG. 4 is a rear view of the camera dolly shown in FIGS. 2 and 3 with various components omitted for purpose of illustration.

FIG. 5 is an enlarged view of the connector panel shown in FIG. 4.

FIG. 6 is a front perspective view of an external battery box for use with the camera dolly shown in FIGS. 2-5.

FIG. 7 is a schematic of an example of the electrical system of the camera dolly shown in FIGS. 1-5.

### DETAILED DESCRIPTION

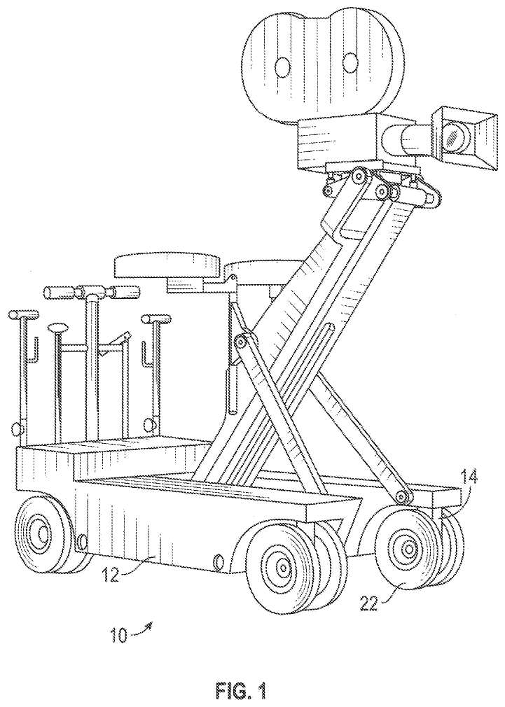

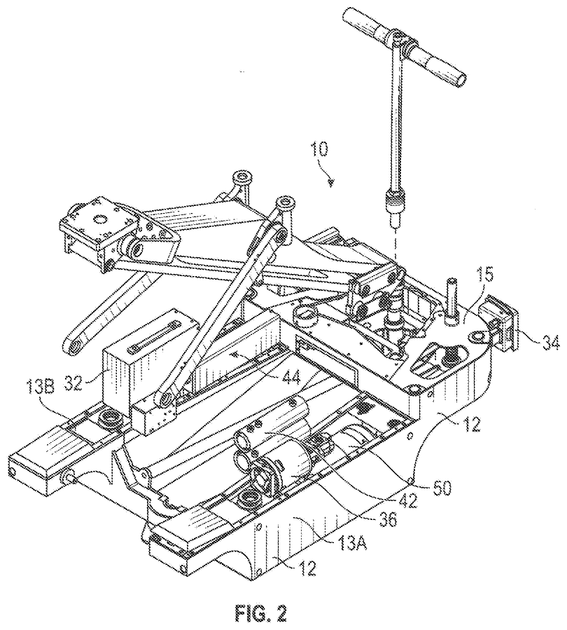

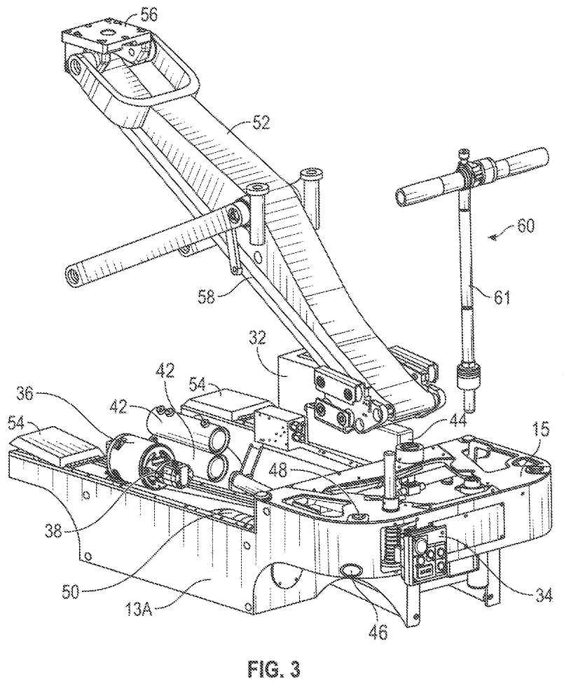

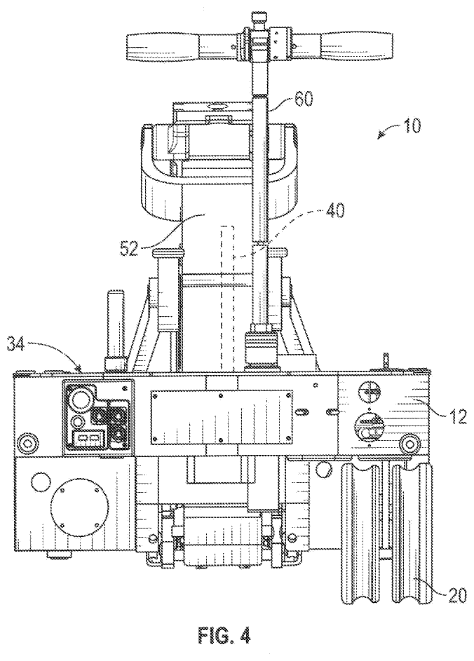

Turning now in detail to the drawings, as shown in FIGS. 1-4, a camera dolly 10 has a chassis 12 with a kingpin 14 at or near each of the corners of the dolly 10. The chassis may be generally U-shaped, having left and right frames or sections 13A, 13B, and a rear frame or section 15. A pair of wheels 20 is rotatably supported on axles on opposite sides of each kingpin 14. A tire 22 is optionally mounted on each of the wheels. Some dollies may use a single wheel on each kingpin. In FIGS. 2-3 and at the left side of FIG. 4, the wheels and kingpins and other components are omitted for purpose of illustration. A steering system has chains or belts engaged with each kingpin for steering the dolly 10. Referring to FIGS. 2-3, the steering system includes a steering transmission in the rear section 15 and a steering handle 60, for example as described in U.S. Pat. No. 6,109,626, incorporated herein by reference. A clutch 61 may be included in the shaft of the steering handle 60 to limit the torque that the handle 60 can apply to the steering system, to help avoid damaging the steering system via excessive force. A hinged door 54 may be provided over each kingpin to allow quick access to a clutch clamp on each kingpin, for releasing the kingpin from engagement with the steering chains or belts. This allows the kingpin to pivot freely, when the dolly 10 is used on track and steering is deactivated.

The arm 52 is pivotally attached to the chassis of the dolly and is raised and lowered via a hydraulic cylinder 40 driven by a hydraulic system including a pump 38 driven by an electric pump motor 36, an accumulator 50, a pressure gauge 48, and valves, for example as described in U.S. Pat. No. 6,626,117, incorporated herein by reference. Auxiliary air tanks 42 may be added to the hydraulic system to increase the capacity of the system. These hydraulic system components may be contained within the left frame 13A. A camera platform 56 at the end of the arm remains horizontal regardless of the arm position via a parallelogram leveling linkage 58.

As shown in FIGS. 2-5, the dolly 10 has an electrical system for powering the pump motor 36, and for also charging and using the on-board battery 32 which may be contained within right frame 13B the chassis 12. The electrical system may also power accessories used with the dolly, such as a remote-controlled camera head. The on-board battery 32 may be a lithium battery made up of multiple cells. The battery 32 may be contained in a battery box allowing for quick installation and removal of the battery 32. An AC to DC converter 44 is wired to the battery 32 and to a wall plug 46 on the dolly, to allow charging the battery 32 (typically when the dolly is idle) by connecting a 110/220 AC line to the wall plug 46 with a cable. The converter 44 converts 110/220 VAC to 32 VDC. The battery 32 is wired indirectly to the motor 36 and to a connector panel 34 at the back of the chassis.

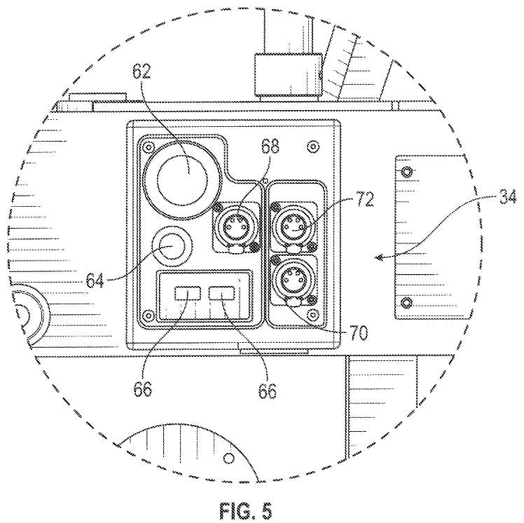

As shown in FIG. 5, the connector panel 34 includes a voltmeter 62 which displays the voltage of the battery 32, indicating its state of charge. An on/off switch 64 controls operation of the motor 36. Although the motor 36 and pump 38 are relatively quiet, the motor 36 is typically only switched on to charge the accumulator before or after actual filming, to avoid creating any noise. The motor 36 and the pump 38 may be instantaneously switched off, to avoid generating any noise, via operation of the switch 64. The switch 64 may optionally be positioned on the rear right side of the dolly, opposite from the connector panel, or it may be a remotely operated switch. An accessory power out connector 68 is connected into the electrical system of the dolly to provide 12 VDC power to an accessory such as a camera head. This allows the accessory to be used on the dolly without having a separate accessory battery.

As shown in FIGS. 2-4 of U.S. Pat. No. 6,109,626, steering chains or belts extend through the left and right frames. The battery 32 may be contained in a space or compartment below the chains in the left and right frames. In ordinary use, the battery 32 is permanently positioned within the frame. In an exceptional situation however, the battery 32 may be removed by loosening and repositioning idler sprockets. This provides sufficient slack in the steering chains to allow the steering chains to be displaced, creating clearance for removal of the battery 32.

A charging connector 70 allows supply of external electrical power to the electrical system for charging the on-board battery 32. An external battery connector 72 on the panel 34 is provided to allow an external battery box 90 to be connected to the electrical system of the dolly, for driving the motor 36, typically for use if the on-board battery 32 is discharged and not able to drive the motor 36. Two USB plugs 66 on the panel 34 may provide 5 VDC output for charging or powering smaller devices, such as phones and tablets. The electrical system has components and circuits for providing the voltages discussed above, either from the on-board battery 32, from an external battery box 90, or from wall current connected to the dolly via a cable to either the charging connector 70 (which is wired to the motor and will drive the motor when the switch 64 is on), or via the wall plug 46 on the chassis of the dolly. The electrical system may be designed so that the pump motor 36 is powered only by the battery 32, and not by any external power source. In this case, the battery 32 is charged via wall current connected to the dolly via a cable, or by an external battery. However, the wall current or external battery is not wired directly to the pump motor 36.

The on-board battery 32 may be 20 to 40 Amp Hour 32 VDC battery. A 30 Amp Hour 32 VDC battery provides for about 45 lifts of the arm 52. Operation of the motor 36 can charge the hydraulic system from about 2900 psi (idle) to 3300 psi (full pressure) in less than one minute, where the motor is a 750 W motor. The pressure gauge 48 provides an indication of how many lifts the hydraulic system can provide before it needs recharging.

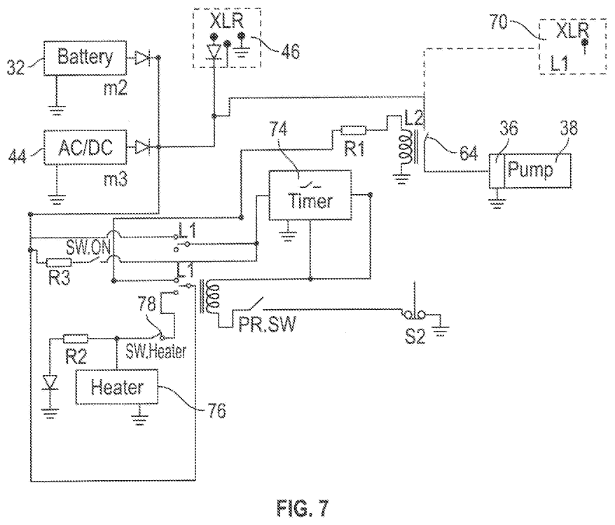

Referring to FIG. 7, a timer 74 may be included in the electrical system to automatically limit operation of the motor 36 to a pre-selected time interval, such as 60 to 120, or 90 seconds. The timer 74 limits inadvertent overcharging of the hydraulic system, by limiting the duration of operation of the pump, in the event that other pressure limiting components, such as pressure switches, become inoperative. A heater 76 is generally included in the electrical system for heating the hydraulic fluid, when the camera dolly is in a low temperature environment. In this case, generally the hydraulic fluid is preheated, and remains heated, via use of the heater 76. The heater 76 may be manually turned on and off via a heater switch 78.

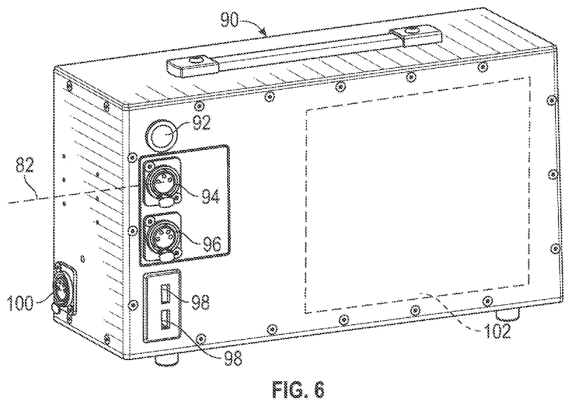

FIG. 6 shows an external battery box 90 which may be used with the dolly 10. The external battery box 90 contains a battery 102 which may also be a lithium battery. The battery 102 is charged via 110/220 VAC supplied through connector 100 to a converter inside of the box 90. The external battery box 90 can be used to power the motor in the dolly by connecting it via a cable 82 from connector 94 to connector 72. The external battery box may also power an accessory via the connector 96. USB connectors 98 may power or charge smaller devices. A switch 92 switches electrical connections to the battery 102 between the connectors 100 and 94-98.

Thus, a novel camera dolly has been shown and described. Various changes and substitutions may of course be made without departing from the spirit and scope of the invention. The invention, therefore, should not be limited, except by the following claims and their equivalents.

1. A camera dolly, comprising:
a chassis;
an arm pivotally attached to the chassis;
a hydraulic system including a pump, an accumulator and a hydraulic actuator connected to the arm, for raising and lowering the arm;
an electric motor mechanically connected to the pump;
an electrical system including a battery and an AC to DC converter in the chassis, the battery and the AC to DC converter electrically connected to the motor.

2. The camera dolly of claim 1 wherein the chassis has a left frame, a right frame, and a rear frame, the battery is a lithium battery having multiple cells, the battery and the AC to DC converter are permanently installed within the left frame of the chassis, and the pump and the accumulator are in the right frame of the chassis.

3. The camera dolly of claim 1 having no manually operated hydraulic pump, wherein the pump is operated only by the motor, and the motor is powered only by the battery.

4. The camera dolly of claim 3 with the motor switched between on and off via a single on/off switch, regardless of the charge state of the battery.

5. The camera dolly of claim 3 further including a charging connector on the connector panel for providing external electrical power from wall current or an auxiliary battery to the electrical system for charging the battery, and with the battery powering the motor.

6. The camera dolly of claim 5 with the electrical system further including an accessory power out connector on the connector panel for providing 12 VDC power to an accessory.

7. The camera dolly of claim 6 with the electrical system further including one or more USB connectors having a 5 VDC output.

8. A camera dolly, comprising:
a chassis having a left frame, a right frame, and a rear frame;
an arm pivotally attached to the chassis between the left frame and the right frame;
a hydraulic system including a pump, an accumulator and a hydraulic actuator connected to the arm, for raising and lowering the arm, the pump and the accumulator in the left frame, and the hydraulic system further including one or more auxiliary air tanks in the left frame;
an electric motor in the left frame, the electric motor mechanically connected to the pump;
an electrical system including a multi-cell lithium battery permanently installed into the right frame, and an AC to DC converter, the battery and the AC to DC converter electrically connected to the motor, and a wall plug connector on the chassis;
a connector panel on the rear frame including an accessory power out connector on the connector panel for providing 12 VDC power to an accessory, and a charging connector on the connector panel for providing external electrical power to the electrical system for charging the battery.

9. The camera dolly of claim 8 with the motor powered only by the lithium battery and external electrical power, if used, charging the lithium battery.

10. The camera dolly of claim 10 with the electrical system including a timer which automatically limits operation of the motor to a preselected time interval.
